(19) United States
(12) Patent Application Publication
(10) Pub. No.: US 2026/0075688 A1
(43) Pub. Date: Mar. 12, 2026

(54) ADVANCING DEVICES AND ADVANCING METHODS FOR ELECTRODE OF ELECTRONIC GLASS FURNACE

(71) Applicant: CAIHONG DISPLAY DEVICES CO., LTD., Xianyang (CN)

(72) Inventors: Feng ZHANG, Xianyang (CN); Ming ZHAO, Xianyang (CN); Longjiang ZHAO, Xianyang (CN)

(73) Assignee: CAIHONG DISPLAY DEVICES CO., LTD., Xianyang (CN)

(21) Appl. No.: 19/394,834

(22) Filed: Nov. 19, 2025

Related U.S. Application Data
(63) Continuation-in-part of application No. PCT/CN2025/111255, filed on Jul. 29, 2025.

(30) Foreign Application Priority Data
Jul. 30, 2024 (CN) 202411033815.X

(51) Int. Cl. H05B 7/109; C03B 5/027; F27D 21/02; F27D 21/04; G05D 3/12; G06T 7/00

(52) U.S. Cl. CPC H05B 7/109; C03B 5/027; F27D 21/02; F27D 21/04; G05D 3/12; G06T 7/0004; F27D 2021/026; G06T 2207/20081; G06T 2207/30164

(57) ABSTRACT

The present disclosure relates to an advancing device and an advancing method for an electrode of an electronic glass furnace. The advancing device includes a driving gear, a plurality of driven gears, a driving motor, a plurality of connecting assemblies, and a fixing and moving assembly. The plurality of driven gears engages with the driving gear. The plurality of driven gears and the driving gear are rotatably connected to the fixing and moving assembly. One end of a central shaft of the driving gear is connected to the driving motor. One end of a central shaft of each of the plurality of driven gears away from the driving motor are connected to each of the plurality of connecting assemblies, respectively. The plurality of driven gears are connected to advancing screws corresponding to a plurality of electrodes of the electronic glass furnace via the plurality of connecting assemblies and perform synchronous driving.

### CROSS-REFERENCE TO RELATED APPLICATIONS

This application is a Continuation-in-part of International Application No. PCT/CN2025/111255, filed on Jul. 29, 2025, which claims priority to Chinese Patent Application No. 202411033815.X, filed on Jul. 30, 2024, the entire contents of each of which are incorporated herein by reference.

### TECHNICAL FIELD

The present disclosure generally relates to a field of auxiliary equipment for an electronic glass furnace, and in particular, to an advancing device and an advancing method for an electrode of an electronic glass furnace.

### BACKGROUND

Electric heating of an electronic glass furnace is currently a main process in the industry, and tin oxide electrodes are the most widely used materials because tin oxide not only has good electrical conductivity but also has a glass clarification function due to its composition. However, the tin oxide electrode is continuously consumed during operation and needs to be periodically advanced into the furnace.

Currently, a conventional process for advancing electrodes is to manually rotate screws from bottom to top in a set sequence, generally operated by one person, with high work intensity. To avoid differences in the advancing amounts between screws, the advancing amount of each screw needs to be manually measured. The entire operation process is cumbersome and has low accuracy.

Therefore, it is desirable to provide an advancing device and an advancing method for an electrode of an electronic glass furnace to solve problems such as a cumbersome advancing process and low accuracy during electrode advancing in the prior art.

### SUMMARY

One or more embodiments of the present disclosure adopt the following technical solution:

In a first aspect, an advancing device for an electrode of an electronic glass furnace includes: a driving gear, a plurality of driven gears, a driving motor, a plurality of connecting assemblies, and a fixing and moving assembly. The plurality of driven gears are engaged with the driving gear, the plurality of driven gears and the driving gear are rotatably connected to the fixing and moving assembly, one end of a central shaft of the driving gear is connected to an output shaft of the driving motor, the driving motor is installed on the fixing and moving assembly, one end of a central shaft of each of the plurality of driven gears away from the driving motor is connected to each of the plurality of connecting assemblies, respectively, and the plurality of connecting assemblies are cooperatively connected to an advancing screw corresponding to each of a plurality of electrodes of the electronic glass furnace, respectively.

In some embodiments, the fixing and moving assembly includes a carriage frame, a guide rail, and a limiting member. The guide rail is installed at a bottom of the carriage frame, and the limiting member is disposed at a connection between the carriage frame and the guide rail.

In some embodiments, the carriage frame is provided with a plurality of first fixing seats and second fixing seats, both ends of the central shaft of the driving gear are provided with the second fixing seats, the central shaft of the driving gear is rotatably connected to the second fixing seats, and one end of a central shaft of each of the plurality of driven gears facing the driving motor are respectively rotatably connected to the plurality of first fixing seats.

In some embodiments, the plurality of first fixing seats and the second fixing seats are fixedly connected to the carriage frame.

In some embodiments, the plurality of first fixing seats and the second fixing seats are bearing seats, the bearing seats are provided with bearings, the central shaft of the driving gear is connected to the bearings on the second fixing seats, and the end of the central shaft of each of the plurality of driven gears facing the driving motor are respectively connected to the bearings on the plurality of first fixing seats.

In some embodiments, each of the plurality of connecting assemblies includes a connector and a flexible coupling, the connector is connected to an end of the central shaft of each of the driven gear away from the driving motor via the flexible coupling, and the connector is cooperatively connected with a head of the advancing screw.

In some embodiments, the connector is provided with an internal hexagonal socket, and the head of the advancing screw is an external hexagonal structure adapted to the internal hexagonal socket.

In some embodiments, the advancing device further includes a positioning mechanism. The positioning mechanism is configured to control the central shaft of each of the plurality of driven gears to move in a direction perpendicular to a plane of the driving gear. Each of the plurality of driven gears is engaged with the driving gear when each of the plurality of driven gears and the driving gear are moved to be in a same plane, and each of the plurality of driven gears is disengaged from the driving gear when each of the plurality of driven gears and the driving gear are moved to be in a different plane.

In some embodiments, at least one torque sensor is disposed between the advancing screw and a corresponding connecting assembly.

In some embodiments, the advancing device further includes a processor and an imaging device. The imaging device is configured to acquire a target image of the plurality of electrodes within the electronic glass furnace.

In a second aspect, an advancing method for an electrode of an electronic glass furnace, performed based on the advancing device for the electrode of the electronic glass furnace, includes: advancing a driving gear and a plurality of driven gears into an operating position via a fixing and moving assembly; performing cooperatively connecting between a plurality of connecting assemblies and an advancing screw corresponding to each of a plurality of electrodes of the electronic glass furnace; starting a driving motor to rotate the driving gear, thereby driving the plurality of driven gears to rotate synchronously, the plurality of driven gears synchronously drive the advancing screw corresponding to each of the plurality of electrodes to rotate during the rotation, and the advancing screws synchronously advance the plurality of electrodes to move.

In a third aspect, another advancing method for an electrode of an electronic glass furnace, performed by a processor, includes: acquiring, at a preset interval, a target image of a plurality of electrodes within the electronic glass furnace via an imaging device; for each electrode of the plurality of electrodes, predicting an estimated consumption rate of the electrode based on the target image of the electrode within the electronic glass furnace during a preset period; determining a first target electrode and a second target electrode from the plurality of electrodes based on a plurality of estimated consumption rates corresponding to the plurality of electrodes; performing a first advancing operation on the first target electrode, and performing a second advancing operation on the second target electrode.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic structural diagram of an advancing device for an electrode of an electronic glass furnace according to some embodiments of the present disclosure;

FIG. 2 is a schematic structural diagram of a driving gear and a driven gear according to some embodiments of the present disclosure;

FIG. 3 is a schematic diagram of fixing of a driving gear and a plurality of driven gears according to some embodiments of the present disclosure;

FIG. 4 is a schematic structural diagram of an end of a central shaft of a driving gear facing a driving motor according to some embodiments of the present disclosure;

FIG. 5 is a schematic structural diagram of a connecting assembly according to some embodiments of the present disclosure;

FIG. 6 is a schematic diagram of engagement between an advancing device and an advancing screw for an electrode of an electronic glass furnace according to some embodiments of the present disclosure;

FIG. 7 is another schematic diagram of engagement between an advancing device and an advancing screw for an electrode of an electronic glass furnace according to some embodiments of the present disclosure;

FIG. 8 is an exemplary schematic diagram of a processor and an imaging device according to some embodiments of the present disclosure;

FIG. 9 is an exemplary flowchart of an advancing process for an electrode of an electronic glass furnace according to some embodiments of the present disclosure;

FIG. 10 is another exemplary flowchart of an advancing process for an electrode of an electronic glass furnace according to some embodiments of the present disclosure.

In the drawings, 11: driving gear; 12: driven gear; 13: driving motor; 21: first fixing seat; 22: second fixing seat; 30: connecting assembly; 31: connector; 32: flexible coupling; 41: carriage frame; 411: motor mounting bracket; 42: guide rail; 43: limiting member; 44: positioning mechanism; 5: advancing screw, 51: head; 52: threaded rod; 60: torque sensor; 81: processor; 82: imaging device.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

In the following, only certain exemplary embodiments are simply described. The described embodiments can be modified in various different ways without departing from the spirit or scope of the present disclosure.

In the description of the present disclosure, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. indicate orientations or positional relationships based on the orientations or positional relationships shown in the drawings. These terms are used only for facilitating the description of the present disclosure and simplifying the description, and do not indicate or imply that the referred apparatus or element must have a specific orientation or be constructed and operated in a specific orientation. Therefore, these terms should not be construed as limiting the present invention.

Furthermore, the terms “first” and “second” are used for descriptive purposes only and cannot be understood as indicating or implying relative importance or implicitly indicating the number of the indicated technical features. Thus, features defined with “first” and “second” may explicitly or implicitly include one or more of such features. In the description of the present invention, the meaning of “a plurality” is two or more, unless explicitly and specifically defined otherwise.

In the present disclosure, unless explicitly specified and defined otherwise, the terms “install”, “connect”, “connected”, “fix”, etc. should be understood broadly. For example, the connection may be a fixed connection, a detachable connection, or an integral connection. The connection may be a mechanical connection, an electrical connection, or a communication connection. The connection may be a direct connection, an indirect connection through an intermediate medium, or an internal connection between two elements or an interaction relationship between two elements. For a person of ordinary skill in the art, the specific meanings of the above terms in the present disclosure can be understood according to specific situations.

The embodiments of the present disclosure are described in detail below with reference to the drawings.

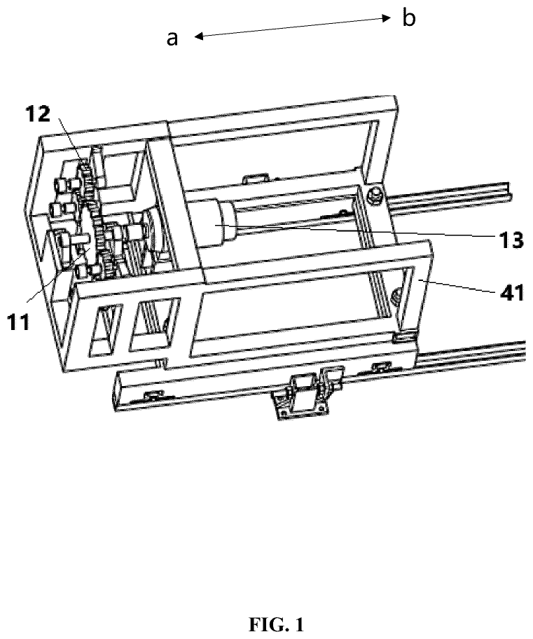

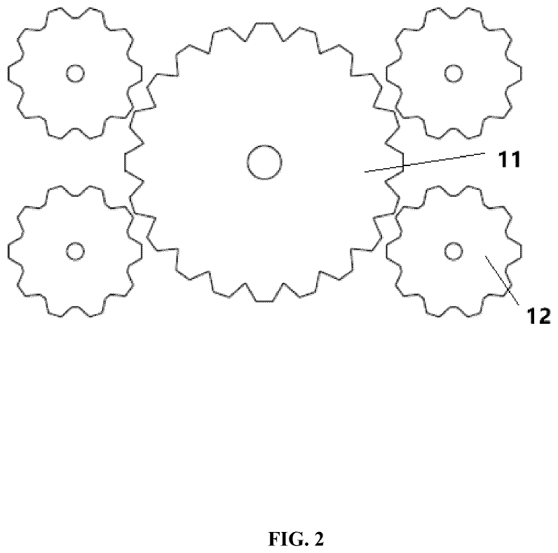

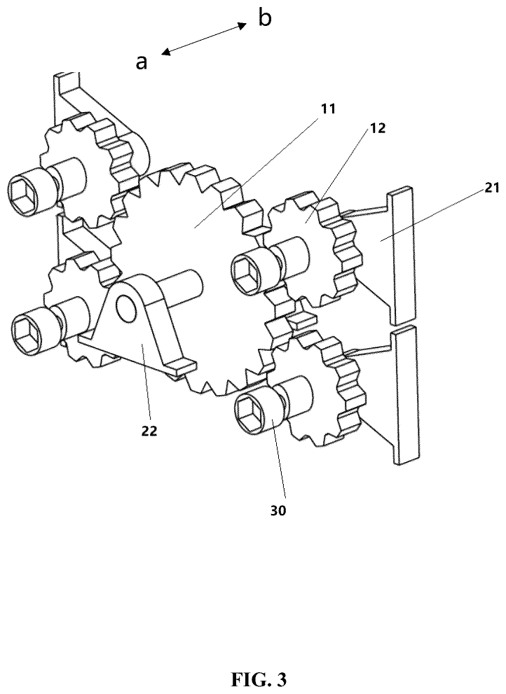

FIG. 1 is a schematic structural diagram of an advancing device for an electrode of an electronic glass furnace according to an embodiment of the present disclosure. FIG. 2 is a schematic structural diagram of a driving gear and a driven gear according to an embodiment of the present disclosure. FIG. 3 is a schematic diagram of fixing of a driving gear and a plurality of driven gears according to an embodiment of the present disclosure.

As shown in FIG. 1, the advancing device for the electrode of the electronic glass furnace includes: a driving gear 11, a plurality of driven gears 12, a driving motor 13, a plurality of connecting assemblies 30, and a fixing and moving assembly.

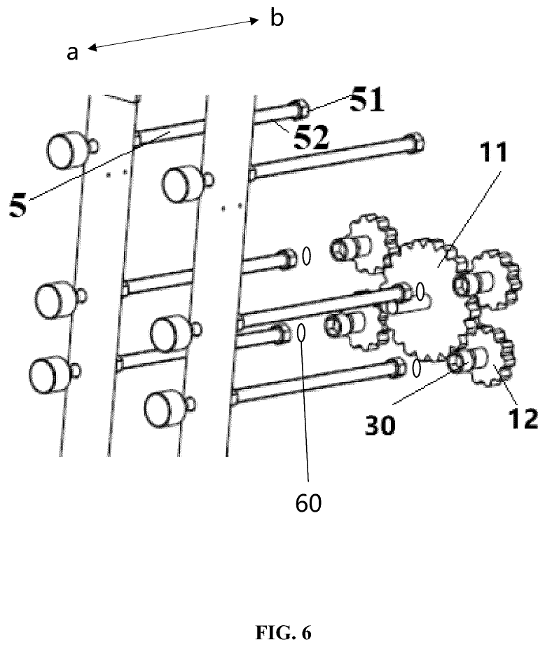

In some embodiments, the plurality of driven gears 12 are all engaged with the driving gear 11. The plurality of driven gears 12 and the driving gear 11 are all rotatably connected to the fixing and moving assembly. One end of a central shaft of the driving gear 11 is connected to an output shaft of the driving motor 13. The driving motor 13 is installed on the fixing and moving assembly. One end of a central shaft of each of the plurality of driven gears 12 away from the driving motor 13 is connected to each of the plurality of connecting assemblies, respectively. The plurality of connecting assemblies 30 are respectively configured to be cooperatively connected to advancing screws 5 (see, FIG. 6) corresponding to a plurality of electrodes of the electronic glass furnace.

In some embodiments, a count of driven gears 12 may be consistent with a count of electrodes. For example, when the count of the electrodes is four, the count of driven gears 12 may also be set to four. Merely by way of example, as shown in FIGS. 2-3, four driven gears 12 and one driving gear 11 are externally engaged. The driven gears 12 and the driving gear 11 are all installed on the fixing and moving assembly. The four driven gears 12 and the one driving gear 11 are all capable of rotating around their respective central shafts. An end a of the central shaft (also referred to as a rotation shaft or a transmission shaft) of the driven gear 12 is provided with the connecting assembly 30. During operations, the four driven gears 12 are connected to heads 51 of the advancing screws 5 of the electrodes of the electronic glass furnace through the connecting assemblies 30 and are synchronously driven. An end b of the central shaft (also referred to as a rotation shaft or a transmission shaft) of the driving gear 11 is connected to the driving motor 13. The four driven gears 12 are distributed at four corners around the driving gear 11. Positions of the driven gears 12 correspond one-to-one to positions of four advancing screws 5 at tails of the electrodes of the electronic glass furnace. The four driven gears 12 are distributed in a rectangular pattern. When the driving gear 11 rotates counterclockwise, the driving gear 11 drives the four driven gears 12 to rotate clockwise. Through the connecting assemblies 30 connected to centers of the respective driven gears 12, synchronous screwing of the four advancing screws 5 is achieved, thereby achieving synchronous advancement of the electrodes.

The connecting assembly 30 refers to an assembly for connecting the central shaft of the driven gear 12 to the advancing screw 5. For example, the connecting assembly 30 may include a socket matching a shape of the advancing screw 5. The advancing screw 5 refers to a screw configured to convert rotation of the driven gear 12 into translation along a direction of the central shaft of the driven gear 12. In some embodiments, the advancing screw 5 includes a threaded rod 52 and a head 51 (see, FIG. 6) provided at one end of the threaded rod 52. One end (e.g., the end a) of the threaded rod 52 is capable of being connected to the electrode. The other end (e.g., the end b) of the threaded rod 52 is provided with the head 51.

The fixing and moving assembly refers to an assembly for fixing or moving a driving part. The driving part refers to a main part configured for providing an advancing force to the electrode. For example, the driving part may include the driving gear 11, the plurality of driven gears 12, and the driving motor 13.

In some embodiments of the present disclosure, by providing the advancing device for the electrode of the electronic glass furnace including the driving gear, the plurality of driven gears, the driving motor, the plurality of connecting assemblies, and the fixing and moving assembly, synchronous advancement of the plurality of electrodes can be achieved, which avoids a situation where advancing amounts differ greatly when advancing individual electrode separately, and also improves accuracy and efficiency of electrode advancing.

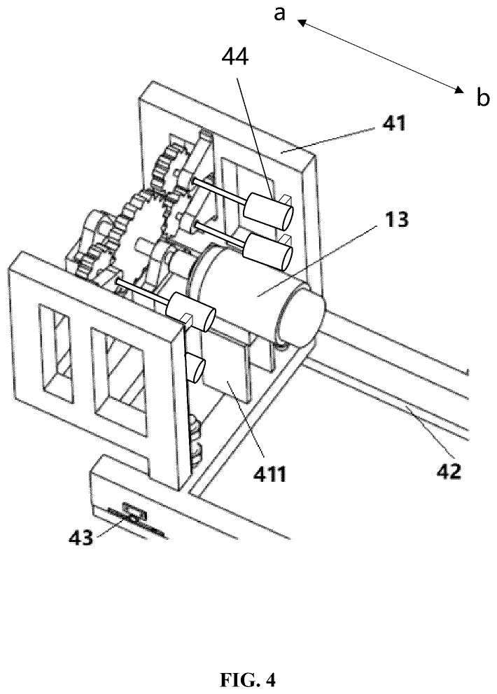

FIG. 4 is a schematic structural diagram of an end of a central shaft of a driving gear facing a driving motor according to some embodiments of the present disclosure.

In some embodiments, the fixing and moving assembly includes a carriage frame 41, a guide rail 42, and a limiting member 43. The carriage frame 41 refers to a frame structure for installing various components of the driving part. An upper part of the carriage frame 41 may be a frame structure made of a rigid material, which is configured for fixing and connecting the driving part. The guide rail 42 refers to a rail for guiding movement of the carriage frame 41. The limiting member 43 refers to a member for limiting the carriage frame 41.

In some embodiments, as shown in FIGS. 3-4, a bottom of the carriage frame 41 is provided with the guide rail 42. The carriage frame 41 is capable of sliding along the guide rail 42. A connection between the carriage frame 41 and the guide rail 42 is provided with the limiting member 43. The carriage frame 41 and the guide rail 42 are locked by using the limiting member 43, so that the carriage frame 41 and the guide rail 42 are relatively stationary. After the limiting member 43 releases the locking of the carriage frame 41 and the guide rail 42, the carriage frame 41 may slide along the guide rail 42 for position adjustment.

In some embodiments, the limiting member 43 may adopt the following structure. The limiting member 43 may be a bolt. A threaded hole for cooperating with the limiting member 43 is provided on the carriage frame 41. A threaded section of the limiting member 43 is connected with the threaded hole. An end of the threaded section of the limiting member 43 abuts against a surface of the guide rail 42. When the carriage frame 41 and the guide rail 42 need to be relatively stationary, the limiting member 43 is rotated to cause the end of the threaded section of the limiting member 43 to tightly press against the guide rail 42. The carriage frame 41 and the guide rail 42 are relatively stationary by using friction between the end of the threaded section of the limiting member 43 and the guide rail 42. When the carriage frame 41 needs to slide along the guide rail 42, the limiting member 43 is rotated to cause the end of the threaded section of the limiting member 43 to disengage from contact with the guide rail 42. At this time, the limiting member 43 releases the locking of the carriage frame 41 and the guide rail 42, and the carriage frame 41 can slide freely along the guide rail 42.

In some embodiments of the present disclosure, by providing the carriage frame, the guide rail, and the limiting member, a position of the advancing device can be flexibly adjusted as needed to adapt to different production scenarios.

In some embodiments, a plurality of first fixing seats 21 and second fixing seats 22 are installed on the carriage frame 41.

The first fixing seat 21 refers to a seat for fixing a central shaft of the driven gear 12. The second fixing seat 22 refers to a seat for fixing a central shaft of the driving gear 11.

In some embodiments, both ends of the central shaft of the driving gear 11 are provided with the second fixing seats 22, the central shaft of the driving gear 11 is rotatably connected to the second fixing seats 22, and one end of a central shaft of each of the plurality of driven gears 12 facing the driving motor 13 are respectively rotatably connected to the plurality of first fixing seats 21.

In some embodiments, the plurality of first fixing seats 21 and the second fixing seats 22 are fixedly connected to the carriage frame 41.

Merely by way of example, as shown in FIGS. 3-4, the first fixing seat 21 is fixed on an inner side of the carriage frame 41. Both ends of the central shaft of the driving gear 11 are provided with the second fixing seats 22. The central shaft of the driving gear 11 is rotatably connected to the second fixing seats 22. An end of the central shaft of the driven gear 12 facing the driving motor 13 is rotatably connected to the first fixing seat 21. The driving motor 13 is fixedly installed on the carriage frame 41. For example, a motor mounting bracket 411 for mounting the driving motor 13 may be provided on the carriage frame 41. The driving motor 13 is detachably installed on the motor mounting bracket 411 by bolts and nuts. The driving motor 13 is located on a side b of the second fixing seat 22 at the end b of the central shaft of the driving gear 11. An output shaft of the driving motor 13 is connected to the central shaft of the driving gear 11. The second fixing seats 22 are fixedly installed on the carriage frame 41.

A fixed connection manner between the first fixing seat 21 and the carriage frame 41 and between the second fixing seat 22 and the carriage frame 41 may be screw fixing, welding, riveting, or the like.

An end of the central shaft of the driven gear 12 facing the driving motor 13 is connected to the first fixing seat 21.

By fixedly connecting the first fixing seat 21 and the second fixing seat 22 to the carriage frame 41, stability of a driving part is ensured when the carriage frame 41 is fixed or moved.

In some embodiments of the present disclosure, by providing the plurality of first fixing seats and the second fixing seats, stability of the driving gear and the driven gears during the advancing process can be better ensured. Providing separate fixing seats for different gears helps improve stability and facilitates maintenance.

In some embodiments, the plurality of first fixing seats 21 and the second fixing seats 22 are bearing seats. A bearing is provided on the bearing seat. The central shaft of the driving gear 11 is connected to a bearing on the second fixing seat 22. An end of the central shaft of the driven gear 12 facing the driving motor 13 is connected to a bearing on the first fixing seat 21. In some embodiments, both ends of the central shaft of the driving gear 11 are connected to bearings on the second fixing seats 22 provided at both ends of the central shaft, respectively.

By using the bearing seats to fix the driving gear 11 and the driven gears 12, stability of the driving part can be enhanced, ensuring smooth progress of the advancing process.

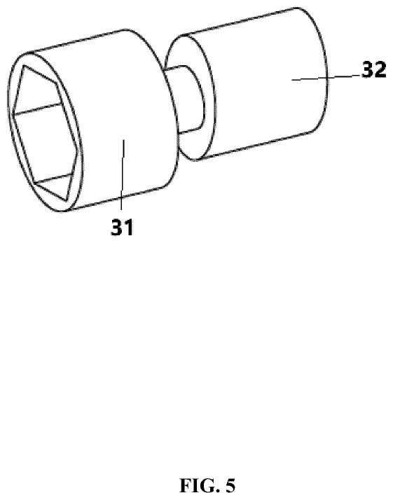

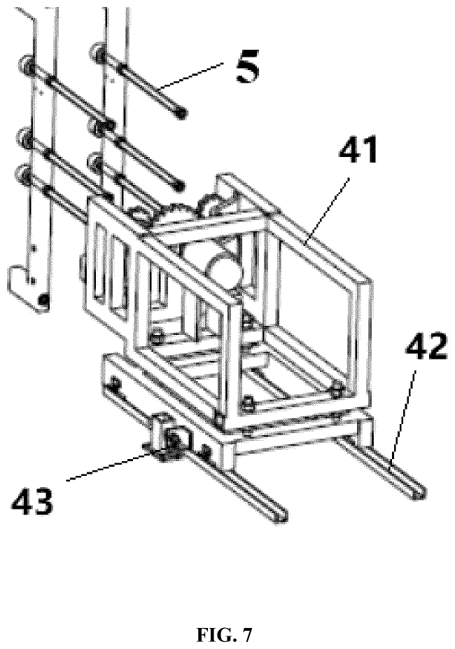

FIG. 5 is a schematic structural diagram of a connecting assembly according to some embodiments of the present disclosure. FIG. 6 is a schematic diagram of engagement between an advancing device and an advancing screw for an electrode of an electronic glass furnace according to some embodiments of the present disclosure. FIG. 7 is another schematic diagram of engagement between an advancing device and an advancing screw for an electrode of an electronic glass furnace according to some embodiments of the present disclosure.

In some embodiments, as shown in FIGS. 5-7, each of the plurality of connecting assemblies 30 includes a connector 31 and a flexible coupling 32. The connector 31 is connected to the end of the central shaft of the driven gear 12 away from the driving motor 13 through the flexible coupling 32. The connector 31 is able to be cooperatively connected to the advancing screw 5 of the electrode of the electronic glass furnace. For example, the connector 31 may clamp the head 51 of the advancing screw 5.

By providing the connector 31 and the flexible coupling 32, when a position of the advancing screw 5 deviates from a theoretical position, the connector 31 is able to clamp a bolt head (i.e., the head 51) of the advancing screw 5 through a flexible adjustment function of the flexible coupling 32, ensuring that torque of the driven gear 12 is transmitted to the advancing screw 5.

In some embodiments, as shown in FIG. 5-7, an internal hexagonal socket (e.g., an internal hexagonal sleeve structure) is provided on the connector 31. The head 51 of the advancing screw 5 is an external hexagonal structure adapted to the internal hexagonal socket. The connector 31 is able to be sleeved on the head 51 along an axial direction. When the connector 31 rotates, the connector 31 drives the advancing screw 5 to rotate synchronously through the head 51. The connector 31 may be made of stainless steel.

In some embodiments of the present disclosure, by providing the internal hexagonal socket on the connector and the external hexagonal structure on the head, the connector and the head can be better adapted. After the cooperative connection, rotation of the driven gear can be better transmitted to the advancing screw.

In some embodiments, the advancing device for the electrode of the electronic glass furnace further includes a positioning mechanism 44.

The positioning mechanism 44 refers to a mechanism for adjusting a position of the driven gear 12. For example, the positioning mechanism 44 may be a lever mechanism. By providing an external handle or an actuator (e.g., a cylinder, an electromagnet, etc.) to control the lever, the driven gear 12 is displaced along a direction of the central shaft. As another example, the positioning mechanism 44 may be a cam mechanism. The driven gear 12 performs a reciprocating motion along the direction of the central shaft by rotating the cam. As another example, the positioning mechanism 44 may be a push rod or a slider mechanism, i.e., movable push rods or sliders corresponding to the plurality of driven gears 12 are designed on the carriage frame 41. The driven gear 12 is finely adjusted in position along the direction of the central shaft by a screw, a hydraulic/pneumatic cylinder, or a motor drive.

In some embodiments, the positioning mechanism 44 is configured to control the central shaft of the driven gear 12 to move in a direction perpendicular to a plane where the driving gear 11 is located, thereby achieving engagement or disengagement between the driven gear 12 and the driving gear 11.

In some embodiments, each of the plurality of driven gears 12 is engaged with the driving gear 11 when each of the plurality of driven gears 12 and the driving gear 11 are moved to be in a same plane, and each of the plurality of driven gears 12 is disengaged from the driving gear 11 when each of the plurality of driven gears 12 and the driving gear 11 are moved to be in a different plane. It can be understood that when the positioning mechanism 44 adjusts one driven gear 12 to a plane slightly lower (or higher) than the driving gear 11, teeth of the driving gear 11 and the driven gear 12 do not contact. Therefore, when the driving gear 11 rotates, the driven gear 12 is not driven. By operating the corresponding positioning mechanism 44 to precisely move the driven gear 12 to the same plane as the driving gear 11, the teeth of the driving gear 11 and the driven gear 12 can be completely engaged. At this time, rotation of the driving gear 11 is able to drive the driven gear 12 to rotate synchronously.

In some embodiments of the present disclosure, by providing the positioning mechanism, one or several driven gears can be flexibly adjusted as needed while other driven gears remain stationary, thereby adapting to more application scenarios. By separately controlling engagement and disengagement of the plurality of driven gears through the positioning mechanism, impact caused by all driven gears simultaneously forced to engage can be avoided, thereby achieving a smoother start. In addition, if a driven gear or an advancing screw connected thereto fails, the positioning mechanism may disengage the corresponding driven gear from driving, avoiding impact on other normally working driven gears.

In some embodiments, as shown in FIG. 6, at least one torque sensor 60 is disposed between the advancing screw 5 and a corresponding connecting assembly 30.

The torque sensor 60 refers to a sensor configured to acquire an advancing resistance of the advancing screw 5. In some embodiments, the torque sensor 60 may be configured to monitor the advancing resistance of the advancing screw 5 in real time. By setting the torque sensor 60, predictive maintenance of the advancing device for an electrode of an electronic glass furnace is facilitated based on data of the advancing resistance.

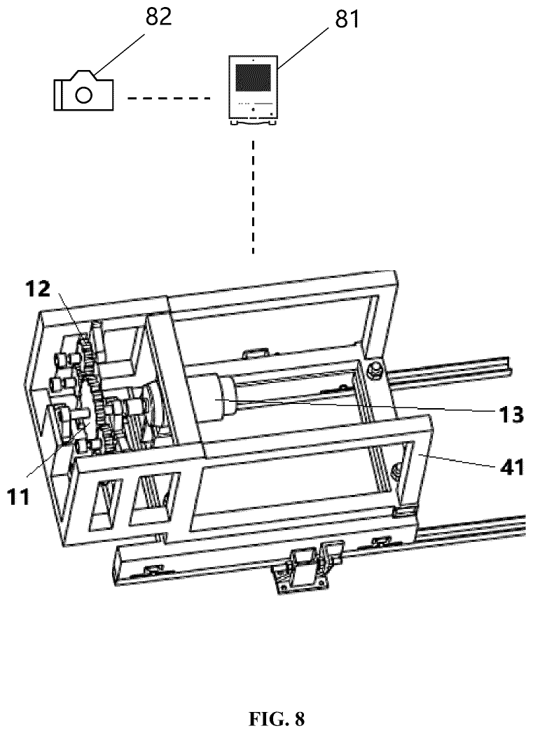

FIG. 8 is an exemplary schematic diagram of a processor and an imaging device according to some embodiments of the present disclosure.

In some embodiments, as shown in FIG. 8, an advancing device for an electrode of an electronic glass furnace further includes a processor 81 and an imaging device 82.

The processor 81 refers to a device or component configured to process data and generate instructions. For example, the processor 81 may be a central processing unit (CPU), a graphics processing unit (GPU), an application-specific integrated circuit (ASIC), or any combination thereof. In some embodiments, the processor 81 may be communicatively connected to other components of the advancing device in the electronic glass furnace. The data may come from the above different components or other data sources. The instructions may be sent to the above different components. The processor 81 may also include other components related to the above content. For example, the processor 81 may also refer to a computer, a mobile phone, a server, an industrial computer, a circuit board with computing functions, or the like.

The imaging device 82 refers to a device configured to acquire image information in the electronic glass furnace. For example, the imaging device 82 may be a visible light camera, an infrared camera, or the like. In some embodiments, the imaging device 82 may be disposed at any feasible position near a furnace mouth of the electronic glass furnace where images of a plurality of electrodes in the electronic glass furnace are able to be captured. In some embodiments, a plurality of imaging devices 82 may be set. For example, positions of the plurality of imaging devices 82 may respectively correspond to different electrodes of the plurality of electrodes. In some embodiments, the imaging device 82 is configured to acquire target images of the plurality of electrodes in the electronic glass furnace.

In some embodiments, the processor 81 may be communicatively connected to the driving motor 13, the torque sensor 60, the imaging device 82, and other components.

The target image refers to image data including an electrode in the electronic glass furnace, and the target image may be used to reflect a state of the electrode. For example, the target image may include an optical image or an infrared image of one or more electrodes in the electronic glass furnace.

In some embodiments, the processor 81 may be configured to determine a consumption state of the electrode after the electrode is immersed in the electronic glass furnace by recognizing the target image, and then predict an estimated consumption rate of the electrode. More details may be found in related descriptions below.

In some embodiments of the present disclosure, by setting the processor and the imaging device, monitoring of a length of the electrode extending outside the electronic glass furnace or a distance from an end face of the electrode to the furnace mouth is facilitated through the target image, thereby monitoring the consumption state of the electrode, so as to better monitor an advancing process of the electrode, and lay a foundation for troubleshooting and adjustment of components during the advancing process.

Some embodiments of the present disclosure further provide an advancing method for an electrode of an electronic glass furnace. The advancing method includes: advancing the driving gear 11 and the plurality of driven gears 12 to an operating position through the fixing and moving assembly; cooperatively connecting the plurality of connecting assemblies 30 to the advancing screws 5 corresponding to the plurality of electrodes of the electronic glass furnace; starting the driving motor 13 to rotate the driving gear 11, thereby driving the plurality of driven gears 12 to rotate synchronously, and the plurality of driven gears 12 synchronously drive the advancing screws 5 corresponding to the plurality of electrodes to rotate during rotation, and the advancing screws 5 synchronously push the plurality of electrodes to move.

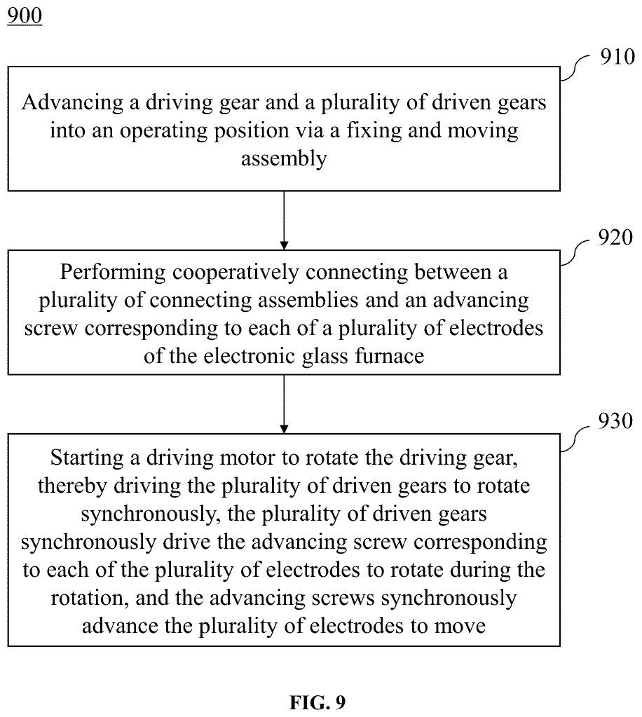

FIG. 9 is an exemplary flowchart of an advancing process for an electrode of an electronic glass furnace according to some embodiments of the present disclosure.

In some embodiments, as shown in FIG. 9, the advancing method for the electrode of the electronic glass furnace may include a process 900 and is implemented based on the advancing device for the electrode of the electronic glass furnace in the above embodiments. The process 900 may include the following operations 910-930.

In 910, the driving gear 11 and the driven gear 12 are advanced into the operating position via the fixing and moving assembly.

The operating position refers to a position where the plurality of connecting assemblies 30 is able to be cooperatively connected to the corresponding plurality of electrodes.

In 920, cooperatively connecting (e.g., engaging) between the plurality of connecting assemblies 30 and the advancing screws 5 corresponding to the plurality of electrodes of the electronic glass furnace is performed.

In some embodiments, the cooperative connecting between the plurality of connecting assemblies 30 and the advancing screws 5 corresponding to the plurality of electrodes of the electronic glass furnace may be implemented via a cooperative connecting between the external hexagonal structure of the head 51 and the internal hexagonal socket of the connector 31. In some embodiments, as long as a shape of the head 51 is adapted to a shape of the connector 31, when the head 51 is cooperatively connected to the connector 31, the connecting assembly 30 and the advancing screw 5 may be relatively fixed, and the head 51 and the connector 31 may also have other shapes.

In 930, the driving motor 13 is started to rotate the driving gear 11, thereby driving the plurality of driven gears 12 to rotate synchronously, the plurality of driven gears 12 synchronously drive the advancing screw 5 corresponding to each of the plurality of electrodes to rotate during rotation, and the advancing screws 5 synchronously advance the plurality of electrodes to move.

In some embodiments, an automatic stop time of the driving motor 13 may be set. The automatic stop time refers to a time when the driving motor 13 stops working after completing advancing, and the automatic stop time may be preset by a technician. In some embodiments, after the automatic stop time of the driving motor 13 is set, the driving motor 13 is started to rotate the driving gear 11, thereby driving the plurality of driven gears 12 to rotate synchronously, and the plurality of driven gears 12 synchronously advance the advancing screw 5 corresponding to each of the plurality of electrodes during rotation; according to the automatic stop time, the driving motor 13 stops working, and electrode advancement is completed.

In some embodiments, the fixing and moving assembly includes the carriage frame 41, the guide rail 42, and the limiting member 43.

In some embodiments, advancing the driving gear 11 and the driven gear 12 to the operating position through the fixing and moving assembly further includes: after the driving gear 11 and the driven gear 12 move to the operating position through the carriage frame 41 on the guide rail 42, locking the limiting member 43, thereby fixing the carriage frame 41 on the guide rail 42. When the driving gear 11 and the driven gear 12 move to the operating position, by using the limiting member 43 for limiting and fixing, stable operation of subsequent advancing operations is ensured, and misalignment caused by relative forces between components during the advancing process is avoided.

Compared with the prior art, beneficial effects of embodiments of the present disclosure include but are not limited to:

The advancing device for the electrode of the electronic glass furnace provided by some embodiments of the present disclosure can synchronously push a plurality of advancing screws at one time through the driving motor, thereby solving a problem of low advancing accuracy in the prior art where individual screws are adjusted separately when advancing an electrode, where the driving motor has a large torque and can meet advancing operations of heavy electrodes, greatly reducing labor intensity.

Further, the fixing and moving assembly of the embodiments of the present disclosure adopts the carriage frame, the guide rail, and the limiting member, so that the entire advancing device can be conveniently moved to the operating position, and fixed by locking the limiting member, ensuring stability and safety during operation.

The advancing method for the electrode of the electronic glass furnace provided by some embodiments of the present disclosure, where the advancing amount of the advancing screw can be indirectly set through the automatic stop time set on the driving motor, can further solve a problem of low accuracy of a screw advancing amount when advancing an electrode in the prior art.

Some embodiments of the present disclosure further provide another advancing method for an electrode of an electronic glass furnace. The advancing method is performed by the processor 81 and includes: acquiring, at a preset interval, a target image of a plurality of electrodes within the electronic glass furnace via an imaging device; for each electrode of the plurality of electrodes, predicting an estimated consumption rate of the electrode based on target images of the electrode in the electronic glass furnace within a preset period; determining a first target electrode and a second target electrode of the plurality of electrodes based on a plurality of estimated consumption rates corresponding to the plurality of electrodes, performing a first advancing operation on the first target electrode, and performing a second advancing operation on the second target electrode. The first advancing operation refers to an operation of performing batch synchronous advancing on the plurality of electrodes through a synchronous driving mechanism of the advancing device, and the second advancing operation refers to an operation of performing advancing control on each electrode individually.

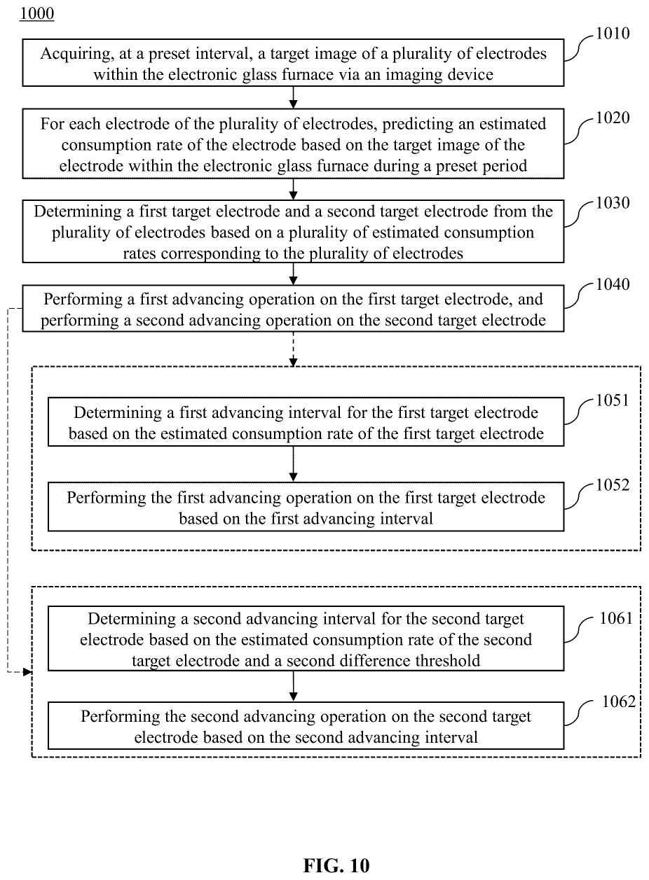

FIG. 10 is another exemplary flowchart of an advancing process for an electrode of an electronic glass furnace according to some embodiments of the present disclosure. As shown in FIG. 10, a process 1000 includes the following operations 1010-1060. In some embodiments, the process 1000 may be performed by the processor 81.

In 1010, at the preset interval, the target image of the plurality of electrodes in the electronic glass furnace is acquired via the imaging device.

The preset interval refers to an interval duration for controlling the imaging device to perform image acquisition. For example, the preset interval may be 1 s, 2 s, etc. When the preset interval is 1 s, it means that the imaging device acquires a target image every 1 second.

The preset interval may be set by a person skilled in the art based on actual requirements.

In 1020, for each electrode of the plurality of electrodes, the estimated consumption rate of the electrode is predicted based on the target image of the electrode in the electronic glass furnace within the preset period.

The preset period refers to a period used for predicting the estimated consumption rate of the electrode. For example, the preset period may be 1 hour, 2 hours, etc., after the electrode initially immerses into the electronic glass furnace and begins operation. Within the preset period, the processor 81 continuously acquires, via the imaging device, the target image of the electrode inside the electronic glass furnace to reflect a change trend of an electrode end face or an immersion length during the preset period.

The preset period may be set by a person skilled in the art according to actual requirements.

The estimated consumption rate refers to an estimated average consumption rate per unit time of the electrode during the preset period.

In some embodiments, the processor 81 may predict the estimated consumption rate of the electrode by a vector matching manner. Exemplarily, the vector matching manner may include the following operations:
(1) Image feature extraction: for the target image of the plurality of electrodes acquired within the preset period, feature vectors capable of characterizing an electrode consumption state are extracted using image processing techniques. The feature vectors may include an area of the electrode end face, a perimeter, an irregularity degree, a pixel distribution of an ablation region, and color or spectral information of a specific substance (e.g., traces of glass melt erosion).
(2) Construction of a consumption pattern database: the consumption pattern database is pre-established, where the consumption pattern database includes historical feature vectors of historical target images and corresponding actual consumption rates thereof. The actual consumption rate may be obtained through manual measurement or long-term monitoring. Each entry in the consumption pattern database forms a mapping relationship between a historical feature vector and an actual consumption rate.
(3) Vector matching and similarity calculation: a similarity between the feature vector extracted for the current electrode during the preset period and the historical feature vectors in the consumption pattern database is calculated. The similarity calculation may adopt Euclidean distance, cosine similarity, or other suitable distance measurement methods.
(4) Consumption rate prediction: Based on the similarity calculation result, one or more historical feature vectors whose similarity with the current feature vector exceeds a similarity threshold are selected. The estimated consumption rate of the current electrode is acquired by performing a weighted average on the actual consumption rates corresponding to the one or more historical feature vectors, combined with their similarities.

More descriptions regarding predicting the estimated consumption rate of the electrode may be found in the relevant descriptions later in the present disclosure.

In some embodiments, the processor 81 may update a preset interval based on a maximum value and a minimum value among estimated consumption rates of a plurality of electrodes, a first difference threshold, and a second difference threshold.

The first difference threshold refers to a threshold related to a difference between actual immersion lengths among the plurality of electrodes. For example, the first difference threshold may be 0.2 mm, 0.3 mm, etc., and may be preset by a technician.

The second difference threshold refers to a threshold related to a deviation of an actual immersion length of a single electrode relative to a target immersion length. For example, the second difference threshold may be 0.3 mm, 0.5 mm, etc., and may be preset by a technician.

The actual immersion length refers to a current actual length by which the electrode extends into the interior of the electronic glass furnace, e.g., an actual distance from an inner edge of a furnace mouth of the electronic glass furnace to the electrode end face.

In some embodiments, the processor 81 may determine the actual immersion length of the electrode in the electronic glass furnace based on an initial immersion length of the electrode, a total advancing length, and the estimated consumption rate. The initial immersion length refers to a length by which the electrode is immersed in the electronic glass furnace before any advancing operation is performed. The total advancing length refers to a total length by which the current electrode has been advanced into the interior of the electronic glass furnace. For example, the processor 81 may determine the actual immersion length of each electrode using the following equation (1):

$${L}_{A} = {L}_{I} + {L}_{S} - {V}_{p} * T \qquad ( 1 )$$

In equation (1), L_{A} denotes the actual immersion length of the electrode, L_{I} denotes the initial immersion length of the electrode, L_{S} denotes the total advancing length of the electrode, Vₚ denotes the estimated consumption rate of the electrode, and T denotes a time for which the electrode has been reacting in the glass melt. The total advancing length may be acquired by adding an actual length that has been advanced (the total length advanced based on a first advancing operation or a second advancing operation) to a compensation length (if any).

The target immersion length refers to a preset ideal immersion depth of the electrode in the electronic glass furnace. The target immersion length may be an optimal depth for ensuring glass melting efficiency and electrode lifespan, and may be preset by a technician based on historical experience or prior knowledge.

In some embodiments, the first difference threshold and the second difference threshold may be determined based on a count of the driven gears 12 and a length of the advancing screw 5.

In some embodiments, the processor 81 may determine the first difference threshold and the second difference threshold by establishing a preset correspondence table. For example, the processor 81 may obtain the first difference threshold and the second difference threshold matching the current electronic glass furnace by querying the preset correspondence table based on a current count of the driven gears 12 and a current length of the advancing screw 5 of the electronic glass furnace. The preset correspondence table includes a correspondence relationship between the count of the driven gears 12 and the length of the advancing screw 5, and the first difference threshold and the second difference threshold. This correspondence relationship may be obtained by a technician based on historical experience or prior knowledge. Exemplarily, a negative correlation exists between the first difference threshold and the second difference threshold, and the count of the driven gears 12 and the length of the advancing screw 5.

In some embodiments of the present disclosure, by determining the first difference threshold and the second difference threshold based on the count of the driven gears and the length of the advancing screw, reliance on fixed empirical values can be eliminated, enabling intelligent adjustment according to actual production conditions. This achieves a refined and adaptive electrode advancing control strategy, thereby better balancing glass quality, production efficiency, and operational stability.

In some embodiments, the processor 81 may determine a final preset interval to update the preset interval by determining a first duration for which a deviation of a single electrode relative to the target immersion length reaches the second difference threshold and a second duration for which a difference between the actual immersion lengths among the electrodes reaches the first difference threshold. Exemplarily, this includes the following operations:
(1) Determination of the first duration: a shortest time required for a distance by which a single electrode deviates from an ideal position to reach the second difference threshold is calculated. The shortest time may be determined by the electrode with the fastest consumption rate, because the electrode with the fastest consumption rate requires the shortest time to deviate by the same distance. The processor 81 may determine the first duration based on the shortest time for the deviation of the single electrode to reach the second difference threshold, e.g., it may be calculated using the following equation (2):

$$F 1 = \frac{Δ L 1}{V max} \qquad ( 2 )$$

where F1 denotes the first duration, ΔL1 denotes the second difference threshold, and Vmax denotes a consumption rate of the electrode with the fastest consumption rate.
(2) Determination of the second duration: a shortest time required for a difference in immersion length between two electrodes to reach the first difference threshold under the influence of the electrode with the fastest consumption rate and the electrode with the slowest consumption rate is calculated. The processor 81 may determine the second duration based on the shortest time for the difference between the actual immersion lengths of the electrodes to reach the first difference threshold, e.g., it may be calculated using the following equation (3):

$$F 2 = \frac{Δ L 2}{V max - V min} \qquad ( 3 )$$

F2 denotes the second duration, ΔL2 denotes the first difference threshold, and Vmin denotes a consumption rate of the electrode with the slowest consumption rate.
(3) Determination of the final preset interval: a smaller value from the first duration and the second duration is selected as the final preset interval to update the preset interval.

In some embodiments of the present disclosure, by updating the preset interval based on the maximum value and the minimum value of the estimated consumption rates of the plurality of electrodes, the first difference threshold, and the second difference threshold, dynamic adaptation of the preset interval to the actual consumption characteristics of the electrodes is achieved. This avoids monitoring lag or monitoring redundancy caused by fluctuations in electrode consumption rates when using a fixed monitoring frequency, thereby enhancing the accuracy and efficiency of electrode consumption monitoring.

In 1030, the first target electrode and the second target electrode among the plurality of electrodes are determined based on the plurality of estimated consumption rates corresponding to the plurality of electrodes.

The first target electrode refers to an electrode in the electronic glass furnace that has a similar consumption rate.

The second target electrode refers to an electrode in the electronic glass furnace with an abnormal consumption rate (e.g., too fast or too slow). In some embodiments, the second target electrode may be advanced on-demand and independently.

In some embodiments, the processor 81 determines the first target electrode and the second target electrode among the plurality of electrodes based on the plurality of estimated consumption rates corresponding to the plurality of electrodes. For example, this may include the following operations:
(1) First, the electrode with the fastest consumption rate and the electrode with the slowest consumption rate are removed from the estimated consumption rates of all electrodes.
(2) After removing the extreme values, an average value of the estimated consumption rates of the remaining electrodes is calculated.
(3) A difference between the estimated consumption rate of each remaining electrode and the average value is calculated, an electrode with a difference not exceeding a preset threshold is determined as the first target electrode, and an electrode with a difference exceeding the preset threshold is determined as the second target electrode. It can be understood that if the estimated consumption rates of all electrodes are near the average value and do not exceed the preset threshold, in this case, the second target electrode may not exist, and all electrodes are determined as the first target electrode.

In 1040, the first advancing operation is performed on the first target electrode, and the second advancing operation is performed on the second target electrode.

In some embodiments of the present disclosure, by classifying the electrodes into the first target electrode and the second target electrode based on the estimated consumption rates and performing the first advancing operation and the second advancing operation respectively, differentiated and precise control of the plurality of electrodes is achieved, avoiding issues of insufficient compensation or over-advancing of some electrodes under traditional unified advancing manners.

In some embodiments, predicting the estimated consumption rate of the electrode based on the target image of the electrode in the electronic glass furnace within a preset period includes: determining the estimated consumption rate of the electrode through a prediction model based on the target image, where the prediction model is a machine learning model.

The prediction model refers to a model configured to determine the estimated consumption rate of the electrode. An input of the prediction model may include the target image of the electrode in the electronic glass furnace within the preset period. An output of the prediction model may include the estimated consumption rate of the electrode.

Types of the prediction model may be various. For example, the prediction model may include one or more of a Convolutional Neural Network (CNN), a Recurrent Neural Network (RNN), or a Long Short-Term Memory network (LSTM), or the like.

In some embodiments, the prediction model may be trained based on a large number of first training samples with first labels. For example, the first training sample of the prediction model may be a sample target image, and the first label of the prediction model is an actual electrode consumption rate corresponding to the sample target image. The first label may be obtained through methods such as historical data accumulation. The historical data accumulation refers to periodically recording the target image of each electrode in the electronic glass furnace during actual production, and simultaneously obtaining the actual consumption rate of each electrode within a corresponding time period through a manual measurement, an optical measurement, or a calculation based on an advancing distance (e.g., recording a total actual consumption distance of the electrode over a preset time period divided by the time to obtain an average consumption rate). The processor 81 forms a first training dataset by mapping the acquired target images with the corresponding actual consumption rate labels one by one, thereby achieving data annotation. For example, for an image showing an ablation state of an electrode end face, the first label may be “0.5 mm/h”.

In some embodiments, the processor 81 may perform a plurality of rounds of iterations, where at least one round of iteration includes: inputting a plurality of first training samples with the first labels into an initial prediction model, constructing a loss function based on the first labels and a result of the initial prediction model, and iteratively updating parameters of the initial prediction model based on the loss function through gradient descent or other manners. When a preset termination condition is satisfied, model training is completed, and a trained prediction model is obtained. The preset termination condition may be convergence of the loss function, a count of iterations reaching a threshold, etc.

In some embodiments, the input of the prediction model may further include: an electrode parameter and/or voltage and current data.

The electrode parameter refers to a characteristic parameter of the electrode in the electronic glass furnace. For example, the electrode parameter may include a chemical composition, a shape, a cross-sectional area, etc., of the plurality of electrodes. In some embodiments, the processor 81 may acquire the electrode parameter from historical data or a design drawing of the electrode.

The voltage and current data refers to voltage data and current data after the electrode is energized within the preset period.

In some embodiments, when the input of the prediction model includes the electrode parameter and/or the voltage and current data, the first training sample may further include a sample electrode parameter and/or sample voltage and current data.

In some embodiments of the present disclosure, by also using the electrode parameter and/or the voltage and current data as inputs of the prediction model, the prediction model can predict the consumption rate of the electrode based on features of more dimensions, improving accuracy of the prediction model.

In some embodiments of the present disclosure, by establishing the prediction model to process the target image of the electrode within the preset period, precise prediction of the estimated consumption rate of the electrode is achieved, avoiding deviations in consumption rate prediction caused by traditional empirical judgment, simple parameter calculation, etc., and providing more reliable data support for subsequent electrode advancing strategy formulation. In some embodiments, by mining the latent electrode consumption characteristics in the target images using the machine learning model, it is possible to achieve deep perception of the electrode consumption status, avoiding misjudgment of consumption speed caused by relying solely on single-dimensional information (such as surface length measurement), and reducing issues of insufficient or excessive electrode advancement caused by such misjudgments.

In some embodiments, the advancing method for the electrode of the electronic glass furnace further includes: determining a first advancing interval for the first target electrode based on the estimated consumption rate of the first target electrode; and performing the first advancing operation on the first target electrode based on the first advancing interval.

In 1051, the first advancing interval for the first target electrode is determined based on the estimated consumption rate of the first target electrode.

The first advancing interval refers to an interval duration for performing a synchronous advancing operation on the first target electrode.

In some embodiments, the processor 81 may calculate the first advancing interval according to the following equation (4) based on an average estimated consumption rate of the first target electrode and the target immersion length.

$${T}_{p u s h} = \frac{{L}_{t a r g e t}}{{V}_{p , avg}} \qquad ( 4 )$$

In equation (4), Tₚᵤₛₕ denotes the first advancing interval, V_{p,avg} denotes the average value of the estimated consumption rates of the first target electrode, and L_{target} denotes the target immersion length, which may be a fixed value or a variable set according to a process target.

In 1052, the first advancing operation is performed on the first target electrode based on the first advancing interval.

In some embodiments, the processor 81 performing the first advancing operation on the first target electrode based on the first advancing interval may include the following operations:
(1) The processor 81 generates a synchronous advancing instruction based on the determined first advancing interval. The synchronous advancing instruction may include an advancing time, an advancing speed, or the like.
(2) Before performing the synchronous advancing, the processor 81 causes the driven gear 12 corresponding to the second target electrode to temporarily disengage from the driving gear 11, and only keeps the driven gear 12 of the first target electrode engaged with the driving gear 11.
(3) The processor 81 sends a start signal to the driving motor 13 of the driving gear 11, causing the driving gear 11 to rotate by a preset angle at a preset angular velocity, thereby driving the engaged driven gear 12 to rotate synchronously.
(4) Each driven gear 12 converts the rotational motion into a linear displacement via the advancing screw 5, driving the first target electrode to move by an equal step length along an advancing direction, thereby achieving synchronous advancement of the first target electrode. The advancing direction refers to a direction in which the central shaft of the driven gear 12 away from the driving motor 13.

In some embodiments of the present disclosure, by performing the first advancing operation on the first target electrode according to the first advancing interval, uniformity of the immersion length of the first target electrode is maintained, avoiding excessive differences in actual immersion lengths between the electrodes due to improper advancing frequency, thereby preventing imbalance in a thermal field and a flow field within the electronic glass furnace, reducing abnormalities in glass melting, clarification, and homogenization processes, and ensuring stability of optical performance and physical performance of electronic glass products.

In some embodiments, the advancing method for the electrode of the electronic glass furnace further includes: when there are a plurality of first target electrodes, in response to determining that a maximum difference among the actual immersion lengths of the plurality of first target electrodes reaches a first difference threshold, performing a compensation operation, the compensation operation including: determining at least one to-be-compensated electrode from the plurality of first target electrodes; and for each to-be-compensated electrode of the at least one to-be-compensated electrode, performing following operations: determining a compensation length and a compensation angle for the to-be-compensated electrode; controlling the driven gears corresponding to all electrodes other than the to-be-compensated electrode to disengage from the driving gear 11, the driving gear 11 is engaged with a target driven gear, and the target driven gear is a driven gear 12 corresponding to the to-be-compensated electrode; and controlling the driving gear 11 to drive the target driven gear to rotate by the compensation angle until the to-be-compensated electrode is advanced by the compensation length.

In some embodiments, the processor 81 may also periodically perform a compensation operation on the first target electrode. Merely by way of example, an interval time of each compensation operation may be determined by the following equation (5):

$${T}_{c o m p} = Δ L 1 \div ( V max - V min ) \qquad ( 5 )$$

T_{comp} denotes the interval time of each compensation operation, ΔL1 denotes the first difference threshold, Vmax denotes a consumption rate of an electrode with a fastest consumption rate, and Vmin denotes a consumption rate of an electrode with a slowest consumption rate.

The compensation operation refers to an operation for independently advancing a specific electrode to compensate for a deviation when immersion length deviations of a plurality of electrodes are excessive.

The to-be-compensated electrode refers to remaining electrodes among the first target electrodes, excluding an electrode with a longest immersion length.

In some embodiments, the processor 81 may determine one or more electrodes among the plurality of first target electrodes, whose actual immersion length is less than a current maximum immersion length, as the to-be-compensated electrode. The current maximum immersion length refers to a maximum value among current actual immersion lengths of the first target electrodes.

The compensation length refers to a displacement length by which the to-be-compensated electrode needs to be further advanced to restore an ideal immersion position of the to-be-compensated electrode in the electronic glass furnace. In some embodiments, the processor 81 may determine the compensation length based on a difference between the actual immersion length of the to-be-compensated electrode and the current maximum immersion length. For example, if the current maximum immersion length is 25 mm and the actual immersion length of the to-be-compensated electrode is 20 mm, the compensation length of the to-be-compensated electrode may be determined as 5 mm.

The compensation angle refers to an angle by which the driving gear 11 needs to be further rotated to move the to-be-compensated electrode by the compensation length. In some embodiments, the processor 81 may determine the compensation angle based on the compensation length of the to-be-compensated electrode and a pitch of the advancing screw 5. Merely by way of example, the processor 81 may calculate the compensation angle by which the driving gear 11 needs to rotate through the following equation (6) based on the compensation length and the pitch of the advancing screw 5.

$$θ = \frac{Δ {L}_{c o m p}}{P} * 360 ° \qquad ( 6 )$$

where θπdenotes the compensation angle, ΔL_{comp} denotes the compensation length, and P denotes the pitch of the advancing screw 5.

Merely by way of example, the compensation operation may be implemented by the processor 81 in following operations:
(1) A precise rotation instruction is sent to the driving motor 13 of the driving gear 11 based on the compensation angle. The driving motor 13 may achieve closed-loop control through encoder feedback, thereby ensuring that the driving gear 11 rotates precisely by the compensation angle.
(2) After the rotation of the driving gear 11 is completed, a corresponding advancing screw 5 is driven by the target driven gear to rotate synchronously, thereby advancing the to-be-compensated electrode to move by a corresponding compensation length, achieving precise compensation of a position of the electrode.
(3) After compensation is completed, the target driven gear is controlled to disengage from the driving gear 11. Subsequently, the processor 81 repeats the above operations for a next to-be-compensated electrode until the compensation operation is performed on all to-be-compensated electrodes.

It can be understood that after the compensation operation is performed on all to-be-compensated electrodes, the actual immersion lengths of all first target electrodes are the same.

In some embodiments of the present disclosure, by controlling driven gears corresponding to all electrodes except the to-be-compensated electrode to disengage from the driving gear, and only allowing the target driven gear to be engaged and driven, independent and precise advancement of a single to-be-compensated electrode is achieved, and an effect of unifying the actual immersion lengths of the first target electrodes is finally reached, ensuring synchronous advancement of the first target electrodes.

In some embodiments, the advancing method for the electrode of the electronic glass furnace further includes: determining a second advancing interval of the second target electrode based on an estimated consumption rate of the second target electrode and a second difference threshold; and performing a second advancing operation on the second target electrode based on the second advancing interval.

In 1061, the second advancing interval of the second target electrode is determined based on the estimated consumption rate of the second target electrode and the second difference threshold.

The second advancing interval refers to an interval duration of independent advancing corresponding to the second target electrode.

In some embodiments, the processor 81 determines the second advancing interval of the second target electrode based on the estimated consumption rate of the second target electrode and the second difference threshold. Merely by way of example, it may be determined in the following manner:
(1) An estimated consumption rate of each second target electrode is acquired.
(2) The second advancing interval is calculated through the following equation (7) based on the second difference threshold:

$${F}_{2 n d} = \frac{Δ L 2}{{V}_{p , 2}} \qquad ( 7 )$$

where F_{2nd} denotes the second advancing interval, ΔL2 denotes the second difference threshold, and V_{p,2} denotes the estimated consumption rate of the second target electrode.

In 1062, the second advancing operation is performed on the second target electrode based on the second advancing interval.

In some embodiments, the processor 81 may perform corresponding advancing operations on different second target electrodes respectively according to the determined second advancing interval, ensuring that the second target electrode reaches a required advancing step length within a specified time.

In some embodiments of the present disclosure, by controlling only the driven gear corresponding to the second target electrode to engage with the driving gear, and performing the second advancing operation on the second target electrode at the second advancing interval, independent and precise advancing of a single second target electrode is achieved, avoiding interference of the advancing operation of the second target electrode with an advancing process of normally operating first target electrodes.

In some embodiments, the advancing method for the electrode of the electronic glass furnace further includes: acquiring monitoring data during the advancing process; determining a fault type and a fault probability via a fault model based on the monitoring data, an electrode parameter, and an electrode advancing parameter, where the fault model is a machine learning model; and in response to determining that the fault type and the fault probability satisfy a preset condition, issuing a warning prompt.

The monitoring data refers to monitoring data related to the electrode within the electronic glass furnace. For example, the monitoring data may include current data of the driving motor 13, vibration data (e.g., amplitude, frequency, etc.), temperature data, advancing resistance of the advancing screw 5, gear wear data (e.g., wear rate, etc.), etc.

In some embodiments, the processor 81 may acquire the monitoring data via related devices arranged in the electronic glass furnace. For example, the processor 81 may acquire current data of the driving motor 13 via a current sensor installed on the driving motor 13, acquire vibration data and temperature data via vibration sensors and temperature sensors arranged at key positions in the electronic glass furnace, acquire advancing resistance of the advancing screw 5 via the torque sensor 60, acquire gear wear data via regular manual inspection or computer inspection (e.g., collecting a gear image and determining its wear degree through existing image recognition technology), etc.

The electrode advancing parameter refers to a preset advancing parameter related to the electrode. For example, the electrode advancing parameter may include advancing speeds of a plurality of electrodes. In some embodiments, the advancing speed of the electrode is proportional to a power of the driving motor 13, and the processor 81 may determine the electrode advancing parameter via the power of the driving motor 13.

The fault type refers to a type of fault that may occur during the advancing process. For example, the fault type may include bearing wear, gear damage, and motor overload. The fault probability refers to a probability of occurrence of a fault corresponding to different fault types.

The fault model refers to a model configured for determining the fault type and the fault probability during the advancing process. In some embodiments, the fault model may be a support vector machine model (SVM) or a neural network model (NN). In some embodiments, an input of the fault model may include the monitoring data, an electrode material, and the electrode advancing parameter, and an output may be the fault type and the fault probability.

In some embodiments, the fault model may be obtained by training based on a large number of second training samples with second labels. The second training samples may include sample monitoring data, sample electrode materials, and sample electrode advancing parameters in historical data. The second labels may be historical actual fault types and fault probabilities corresponding to the second training samples. The second labels may be automatically annotated by the processor 81 based on the historical data.

In some embodiments, the processor 81 may perform a plurality rounds of iterations, where at least one round of iterations includes: inputting one or more second training samples into an initial fault model to obtain outputs corresponding to the one or more second training samples; substituting the outputs of the initial fault model and the actually corresponding second labels into a predefined loss function to calculate a value of the loss function; and iteratively updating the initial fault model based on the loss function, e.g., updating based on a gradient descent method. When the value of the loss function satisfies an iteration completion condition, the training is completed, and a trained fault model is obtained. The iteration completion condition may include convergence of the loss function, or the number of iterations reaching a threshold, etc.

In some embodiments, the input of the fault model may further include glass melt parameters. The glass melt parameters are related parameters reflecting characteristics of a glass melt to be prepared. For example, the glass melt parameters may include indicators of the glass melt to be prepared, such as uniformity (e.g., optical uniformity, compositional uniformity), impurity content, number of bubbles, etc. In some embodiments, when the input of the fault model includes the glass melt parameters, the second training samples may further include sample glass melt parameters.

The preset condition refers to a condition used to determine whether to issue a warning prompt. In some embodiments, the preset condition may be that a fault probability corresponding to any fault type is higher than a preset probability threshold.

The warning prompt refers to a prompt message for a potential fault. In some embodiments, the warning prompt may be a text prompt, a voice prompt, a light-on prompt (e.g., different fault types correspond to lights of different colors being turned on), etc.

In some embodiments of the present disclosure, by utilizing the trained fault model to determine the fault type and the fault probability, it helps to detect potential equipment hazards in advance, avoid sudden shutdowns, extend the service life of the advancing device, and reduce maintenance costs.

It should be noted that the above descriptions are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

What is claimed is:

1. An advancing device for an electrode of an electronic glass furnace, comprising: a driving gear, a plurality of driven gears, a driving motor, a plurality of connecting assemblies, and a fixing and moving assembly; wherein
the plurality of driven gears are engaged with the driving gear, the plurality of driven gears and the driving gear are rotatably connected to the fixing and moving assembly, one end of a central shaft of the driving gear is connected to an output shaft of the driving motor, the driving motor is installed on the fixing and moving assembly, one end of a central shaft of each of the plurality of driven gears away from the driving motor is connected to each of the plurality of connecting assemblies, respectively, and the plurality of connecting assemblies are cooperatively connected to an advancing screw corresponding to each of a plurality of electrodes of the electronic glass furnace, respectively.

2. The advancing device according to claim 1, wherein the fixing and moving assembly includes a carriage frame, a guide rail, and a limiting member;
the guide rail is installed at a bottom of the carriage frame, and the limiting member is disposed at a connection between the carriage frame and the guide rail.

3. The advancing device according to claim 2, wherein the carriage frame is provided with a plurality of first fixing seats and second fixing seats, both ends of the central shaft of the driving gear are provided with the second fixing seats, the central shaft of the driving gear is rotatably connected to the second fixing seats, and one end of a central shaft of each of the plurality of driven gears facing the driving motor are respectively rotatably connected to the plurality of first fixing seats.

4. The advancing device according to claim 3, wherein the plurality of first fixing seats and the second fixing seats are fixedly connected to the carriage frame.

5. The advancing device according to claim 3, wherein the plurality of first fixing seats and the second fixing seats are bearing seats, the bearing seats are provided with bearings, the central shaft of the driving gear is connected to the bearings on the second fixing seats, and the end of the central shaft of each of the plurality of driven gears facing the driving motor are respectively connected to the bearings on the plurality of first fixing seats.

6. The advancing device according to claim 1, wherein each of the plurality of connecting assemblies includes a connector and a flexible coupling, the connector is connected to an end of the central shaft of each of the driven gear away from the driving motor via the flexible coupling, and the connector is cooperatively connected with a head of the advancing screw.

7. The advancing device according to claim 6, wherein the connector is provided with an internal hexagonal socket, and the head of the advancing screw is an external hexagonal structure adapted to the internal hexagonal socket.

8. The advancing device according to claim 1, further comprising a positioning mechanism, wherein the positioning mechanism is configured to control the central shaft of each of the plurality of driven gears to move in a direction perpendicular to a plane of the driving gear; each of the plurality of driven gears is engaged with the driving gear when each of the plurality of driven gears and the driving gear are moved to be in a same plane, and each of the plurality of driven gears is disengaged from the driving gear when each of the plurality of driven gears and the driving gear are moved to be in a different plane.

9. The advancing device according to claim 1, wherein at least one torque sensor is disposed between the advancing screw and a corresponding connecting assembly.

10. The advancing device according to claim 8, further comprising a processor and an imaging device, wherein the imaging device is configured to acquire a target image of the plurality of electrodes within the electronic glass furnace.

11. An advancing method for an electrode of an electronic glass furnace, wherein the advancing method is performed based on the advancing device for the electrode of the electronic glass furnace according to claim 1, comprising:
advancing a driving gear and a plurality of driven gears into an operating position via a fixing and moving assembly;
performing cooperatively connecting between a plurality of connecting assemblies and an advancing screw corresponding to each of a plurality of electrodes of the electronic glass furnace;
starting a driving motor to rotate the driving gear, thereby driving the plurality of driven gears to rotate synchronously, the plurality of driven gears synchronously drive the advancing screw corresponding to each of the plurality of electrodes to rotate during the rotation, and the advancing screws synchronously advance the plurality of electrodes to move.

12. The advancing method according to claim 11, wherein the fixing and moving assembly includes a carriage frame, a guide rail, and a limiting member; and
the advancing a driving gear and a plurality of driven gears into an operating position via a fixing and moving assembly further includes:
after the driving gear and the plurality of driven gears are moved to the operating position on the guide rail via the carriage frame, locking the limiting member, thereby fixing the carriage frame on the guide rail.

13. The advancing method according to claim 11, further comprising:
after setting an automatic stop time of the driving motor, starting the driving motor to rotate the driving gear, thereby driving the plurality of driven gears to rotate, the plurality of driven gears synchronously advance the advancing screw corresponding to each of the plurality of electrodes during rotation;
wherein according to the automatic stop time, the driving motor stops working and completes the advancement of the plurality of electrodes.

14. An advancing method for an electrode of an electronic glass furnace, wherein the advancing method is executed by a processor, comprising:
acquiring, at a preset interval, a target image of a plurality of electrodes within the electronic glass furnace via an imaging device;
for each electrode of the plurality of electrodes, predicting an estimated consumption rate of the electrode based on the target image of the electrode within the electronic glass furnace during a preset period;
determining a first target electrode and a second target electrode from the plurality of electrodes based on a plurality of estimated consumption rates corresponding to the plurality of electrodes; and
performing a first advancing operation on the first target electrode, and performing a second advancing operation on the second target electrode.

15. The advancing method according to claim 14, wherein the predicting an estimated consumption rate of the electrode based on the target image of the electrode within the electronic glass furnace during a preset period includes: determining the estimated consumption rate of the electrode via a prediction model based on the target image, and the prediction model is a machine learning model.

16. The advancing method according to claim 14, further comprising:
determining a first advancing interval for the first target electrode based on the estimated consumption rate of the first target electrode; and
performing the first advancing operation on the first target electrode based on the first advancing interval.

17. The advancing method according to claim 16, further comprising:
when there are a plurality of first target electrodes, in response to determining that a maximum difference among actual immersion lengths of the plurality of first target electrodes reaches a first difference threshold, performing a compensation operation, the compensation operation including:
determining at least one to-be-compensated electrode from the plurality of first target electrodes;
for each of the at least one to-be-compensated electrode, performing following operations:
determining a compensation length and a compensation angle for the to-be-compensated electrode;
controlling the driven gears corresponding to all electrodes other than the to-be-compensated electrode to disengage from the driving gear, the driving gear is engaged with a target driven gear, and the target driven gear is a driven gear corresponding to the to-be-compensated electrode; and
controlling the driving gear to drive the target driven gear to rotate by the compensation angle until the to-be-compensated electrode is advanced for the compensation length.

18. The advancing method according to claim 14, further comprising:
determining a second advancing interval for the second target electrode based on the estimated consumption rate of the second target electrode and a second difference threshold; and
performing the second advancing operation on the second target electrode based on the second advancing interval.

19. The advancing method according to claim 14, further comprising:
acquiring monitoring data during an advancing process;
determining a fault type and a fault probability via a fault model based on the monitoring data, an electrode parameter, and an electrode advancing parameter, wherein the fault model is a machine learning model; and
in response to determining that the fault type and the fault probability satisfy a preset condition, issuing a warning prompt.
